(19) United States
(12) Patent Application Publication
(10) Pub. No.: US 2013/0045322 A1
(43) Pub. Date: Feb. 21, 2013

(54) EDIBLE OIL COMPOSITION

(71) Applicants: Frank Emile Wubbolts, Weesp (NL); Lucia Izquierdo, Weesp (NL); Erik Johan Anton Schweitzer, Womerveer (NL); Hangkam Man, Wormerveer (NL); Cynthia Akkermans, Weesp (NL)

(72) Inventors: Frank Emile Wubbolts, Weesp (NL); Lucia Izquierdo, Weesp (NL); Erik Johan Anton Schweitzer, Womerveer (NL); Hangkam Man, Wormerveer (NL); Cynthia Akkermans, Weesp (NL)

(21) Appl. No.: 13/695,125

(22) PCT Filed: Apr. 21, 2011
(86) PCT No.: PCT/EP11/02033

§ 371 Date: Oct. 29, 2012

(30) Foreign Application Priority Data
Apr. 30, 2010 (EP) 10250865.2

(51) Int. Cl. A23D 9/00; A23D 9/05

(52) U.S. Cl. 426/606; 426/417; 426/531; 426/660; 426/607

(57) ABSTRACT

A method of preparing an edible oil composition, suitable for use in the preparation of a food product, comprises mixing from 1% to 15% by weight of fat particles with a liquid oil and storing the resulting composition for up to 10 weeks, wherein the mixing and storing conditions provide the composition in a form after storage that is pourable.

This invention relates to an edible oil composition, to a method for its preparation and to a method of making a food product using the composition.

Oils and fats are important components of many food products and they can contribute structure, texture and flavour to the products as well as acting as a source of energy. Often, food products that contain liquid oils also contain a structuring agent. Structuring agents are generally fats that are solid at room temperature (20° C.) and that provides structure to the oil phase.

WO 2009/090416 discloses a confectionery water-in-oil emulsion comprising a fat phase; an emulsifier; and an aqueous phase; wherein the fat phase comprises a first fat, such as cocoa butter, that can exist in more than one crystal form, present substantially in a single crystal form having a first melting point; and a second fat, such as palm oil, having a second melting point lower than the first melting point.

U.S. Pat. No. 5,858,445 describes a margarine fat blend comprising 5 to 14% of a structuring agent, also termed a hardstock. The hardstock is a stearin fraction of an interesterified mixture of 25 to 65% unhardened lauric fat stearin and 75 to 35% unhardened C16+ fat stearin.

EP-A-1795257 describes a method of stabilising an edible dispersion comprising oil using a micronized fat powder. The micronized fat powder acts as a structuring agent.

WO 2010/053360 describes a dispersion of a structuring agent.

In commercial use, it would be desirable to provide a mixture of edible oil and structuring agent to a customer that manufactures food products. However, it has been found that storing a mixture of a liquid oil and a structuring agent for any significant amount of time is difficult since the structuring agent tends to increase the viscosity of the mixture making it non-pourable and difficult to handle. This makes pumping and transport of the mixture problematic.

It has now been found that it is possible, surprisingly, to provide a mixture of liquid oil and structuring agent that remains pourable on storage but allows the structuring properties of the structuring agent to be “released” at a later stage in the process when a food product is manufactured.

Accordingly, the present invention provides a method of preparing an edible oil composition, suitable for use in the preparation of a food product, comprising mixing from 1% to 15% by weight of fat particles with a liquid oil and storing the resulting composition for up to 10 weeks, wherein the mixing and storing conditions provide the composition in a form after storage that is pourable.

In another aspect, the invention provides a pourable edible oil composition, suitable for use in the preparation of a food product, comprising from 1% to 15% by weight of fat particles dispersed in a liquid oil, having a pourability of from 0.2 to 0.6 cm/g and/or a viscosity of less than 30,000 cP as determined using a Brookfield viscometer after 10 seconds using a spindle S-64, at a speed of 1.5 rpm.

Yet another aspect of the invention is a method of making a food product comprising mixing the edible oil composition of the invention with one or more additional edible components.

A further aspect of the invention is the use of the edible oil composition of the invention in the manufacture of a food product.

The method of the invention provides a dispersion or suspension of a structuring agent in a liquid oil that remains pourable. Preferably, the composition after storage has a pourability of from 0.2 to 0.6 cm/g, more preferably from 0.30 to 0.55 cm/g, as determined by the method described in the examples section below. The pourability of the composition after storage may be defined in other ways, for example, the composition after storage preferably has a viscosity of less than 30,000 cP as determined using a Brookfield viscometer after 10 seconds using a spindle S-64, at a speed of 1.5 rpm.

The fat is in the solid state (or substantially in the solid state) in the edible oil composition of the invention. The fat may be any edible fat that is solid at 20° C. and is capable of acting as a structuring agent in a food product. Preferably, the fat is: a cocoa butter equivalent (CBE) (such as shea stearin); or cocoa butter; or palm oil stearin.

The liquid oil may be any liquid oil (i.e., an oil that is liquid at 20° C.) containing triglycerides that is useful in a food product. Examples of suitable liquid oils include soybean oil, rapeseed oil, sunflower oil, safflower oil, corn oil and mixtures thereof. Sunflower oil and safflower oil, and their mixtures, are particularly preferred Preferably, the liquid oil comprises sunflower oil.

Preferably, the fat particles are micronized fat. The fat particles may be produced by a method which comprises spraying a mixture of liquid fat containing a gas in a liquefied or supercritical state. Suitable methods are disclosed in EP-A-1795257 and in WO 2010/053360.

Thus, the fat particles may be produced by a method comprising: providing the fat in the liquid state together with a gas in a liquefied or supercritical state, and optionally water, at elevated pressure; and spraying the mixture to a lower pressure to form the fat particles. The fat particles are produced in the solid state and this may require cooling.

Alternatively, the fat particles are not produced by a method comprising: providing the fat in the liquid state together with a gas in a liquefied or supercritical state, and water, at elevated pressure; and spraying the mixture to a lower pressure to form the fat particles.

The fat particles preferably have at least one dimension of less than 1 μm. For example, the fat particles may be in the form of platelets or having a thickness of less than 1 μm, such as from 0.01 to 0.5 μm or bubbles having a wall thickness of less than 1 μm, such as from 0.01 to 0.5 μm.

Preferably at least 95% of the fat particles have at least one dimension of less than 1 μm. For example, at least 95% of the fat particles may be in the form of platelets having a thickness of less than 1 μm, such as from 0.01 to 0.5 μm or bubbles having a wall thickness of less than 1 μm, such as from 0.01 to 0.5 μm.

Preferably, the fat particles and the liquid oil are mixed under low shear.

Typically, the fat particles and the liquid oil are mixed at a temperature of from 5° C. to 40° C., more preferably from 10° C. to 30° C.

Preferably, the composition is stored at a temperature of from 6° C. to 35° C., more preferably from 10° C. to 30° C. The composition is stored for up to 10 weeks, for example from 1 day to 8 weeks or from 2 days to 6 weeks, such as from 2 days to 3 weeks. Preferably, the composition is subjected to continuous or intermittent stirring during storage as this has been found to be beneficial to stability on storage.

The compositions may be stored at a higher temperature than the mixing temperature.

The fat particles are present in the edible oil composition in an amount of from 1 to 15% by weight, preferably from 2 to 13% by weight, such as from 5 to 12% or from 6 to 11% by weight.

The composition that is produced by the method of the invention is a pourable edible oil composition, suitable for use in the preparation of a food product, comprising from 1% to 15% by weight of fat particles dispersed in a liquid oil, having a pourability of from 0.2 to 0.6 cm/g and/or a viscosity of less than 30,000 cP as determined using a Brookfield viscometer after 10 seconds using a spindle S-64, at a speed of 1.5 rpm.

Compositions of the invention optionally contain an emulsifier, such as lecithin, more preferably in an amount of up to 2% by weight (or up to 1% by weight) of the composition. Preferably, the emulsifier is incorporated in (or otherwise associated with) the fat particles. In other words, the fat particles preferably comprise an emulsifier prior to mixture with the liquid oil.

The food product may be in the form of an emulsion, such as a water-in-oil or oil-in-water emulsion. When the food product is in the form of an emulsion, it may be formed by a method which comprises mixing the composition with a water phase. Typically, an emulsifier (such as lecithin) will also be present to stabilise the emulsion.

The food product is preferably a confectionery product. Confectionery products include fillings and coatings. The edible oil composition of the invention preferably constitutes the fat in the filling or the coating.

Confectionery products typically comprise one or more confectionery additives. The confectionery products preferably comprise, in addition to the edible oil composition of the invention, one or more confectionery additives selected from sugar, cocoa powder, milk powder, yoghurt powder, flavouring and emulsifier. Preferably, the confectionery products comprise at least sugar and cocoa powder and, optionally, one or more of the other components. Other confectionery products comprise at least sugar and flavouring and, optionally, one or more of the other components. Additional components such as colouring agents and preservatives may optionally be present in the compositions. Sugar includes sucrose, dextrose and fructose (preferably sucrose). Flavourings include, for example, strawberry, raspberry, vanilla, mint, orange, lemon, lime, coffee and the like. An example of a suitable emulsifier is lecithin. The confectionery products may contain nut solids (e.g., from peanuts, almonds, hazelnuts, walnuts, cashew nuts, pistachio nuts, macadamia nuts and pecan nuts), such as nut paste.

The confectionery product may be an emulsion, such as a water-in-oil emulsion.

The confectionery products are preferably adapted to be stored and/or sold and/or consumed at ambient temperature i.e., 10° C. to 30° C. Alternatively, the confectionery products may be frozen products such as ice cream. The confectionery product may comprise a substrate such as a biscuit, sponge or wafer, to which a coating or filling is applied, and may be impregnated into the wafers. The biscuits, sponges or wafers can be present as single layers or in multiple layers.

The confectionery products may comprise a filling covered with an outer layer of chocolate, either when applied on biscuits, sponges or wafers, or when not so applied. Thus, a preferred confectionery product comprises a chocolate outer layer filled with a filling, optionally comprising a biscuit, sponge or wafer in association with the filling. Typically, the outer layer of chocolate will encapsulate the filling and the biscuit or wafer, if present. The confectionery product may be a bar, optionally divided into segments. The segments may be adapted to allow part of the product to be broken off by the user and consumed separately from the remainder of the product.

The confectionery product may be a filling or coating that forms part of a bakery product. Baked products include bread, cakes, biscuits and sponges. A baked product may comprise a biscuit, sponge or wafer comprising two or more layers of biscuit, sponge or wafer, with the filling between adjacent layers. The bakery product may comprise two layers of biscuit, sponge or wafer with the filling sandwiched between the layers.

The filled confectionery products will generally be packaged, for example in a wrapper, for sale.

Confectionery fillings and coatings may be made by combining one or more confectionery additives selected from sugar, cocoa powder, milk powder, yoghurt powder, flavouring and emulsifier, with the composition of the invention. Typically, the components will be mixed at a temperature of greater than 40° C., such as from 50-80° C.

Confectionery products may be made, for example, by filling an edible substrate with a filling according to methods well known in the art. Suitable edible substrates include biscuits, wafers and chocolate shells.

When the food product is a confectionery product, the fat particles in the edible oil composition preferably comprise cocoa butter or a cocoa butter equivalent (CBE) such as shea stearin.

A preferred composition of the invention, therefore, is a pourable edible oil composition, suitable for use in the preparation of a confectionery product, comprising from 1% to 15% by weight of particles of cocoa butter or a cocoa butter equivalent (CBE) dispersed in a liquid oil, having a pourability of from 0.2 to 0.6 cm/g and/or a viscosity of less than 30,000 cP as determined using a Brookfield viscometer after 10 seconds using a spindle S-64, at a speed of 1.5 rpm.

Alternatively, the food product may be a margarine or a spread.

One embodiment of the composition of the invention is a pourable edible oil composition, suitable for use in the preparation of a margarine or spread, comprising from 1% to 15% by weight of particles of palm oil stearin dispersed in a liquid oil comprising sunflower oil, having a pourability of from 0.2 to 0.6 cm/g and/or a viscosity of less than 30,000 cP as determined using a Brookfield viscometer after 10 seconds using a spindle S-64, at a speed of 1.5 rpm.

The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout the specification, all percentages, parts and ratios are by weight unless indicated otherwise.

### EXAMPLES

### Pourability Test

### Protocol

The instrument employed for the measurement of the pourability consists of a 10 ml plastic cylinder (internal diameter, =16 mm) with both ends open and a plate with concentric circles. These concentric circles are used to indicate the distance the fluid has traveled during a certain period of time.

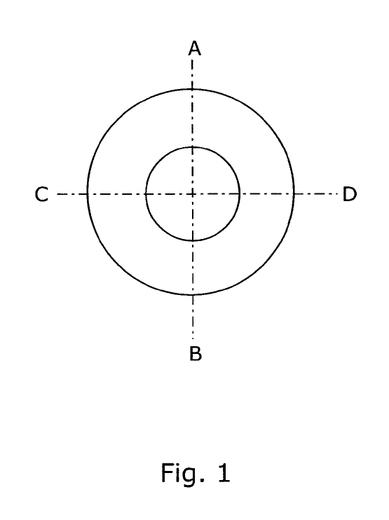

The pourability measurement is carried out following the steps showed below.
1. The plastic cylinder is placed at the central circle of the concentric circles and it is filled with the sample (10 ml).
2. Then the cylinder is removed so that the sample starts to flow. At this point, it is necessary to start measuring the time.
3. After 40 seconds, the distance the fluid has covered is measured at four different points of the concentric circles (A, B, C, and D) as shown in FIG. 1.
4. The average of the four measures is calculated and the mean distance is determined.
5. The weight of the board is measured before and after the test is carried out so that the mass of sample on the board can be calculated.
6. As the distance traveled by the composition depends on the amount of composition, the pourability results will be expressed in cm/g.

$$Pourability = \frac{mean distance ( cm )}{mass sample ( g )}$$

This procedure is repeated at least three times for each sample in order to obtain several values and to calculate the mean value.

### Materials and Methods

### Materials

Fat powder was produced from a palm oil stearin having an iodine value (IV) of 14 (available from Loders Croklaan BV, Wormerveer, The Netherlands) by ScMM (Supercritical Melt Micronization) technique operated on a continuous basis at 20 weight % CO₂ in fat at 300 bar and a pre-expansion temperature of 50° C. using a 340 μm Spraying Systems SK series spray drying nozzle. The oil employed for the production of the samples was sunflower oil.

### Methods

### Production of Samples

### Production of the Fat-in-Oil Blends

Samples were produced by heating up/cooling down the oil to the desired temperature and blending the appropriate amount of fat powder in the oil using a spoon (low shear). Once the samples were produced, they were stored at the desired temperature in storage cabinets for 3 weeks. Processing conditions and compositions of the samples are shown in the table below.

TABLE 1
Fat content, mixing and storage temperatures of the samples.

| | Fat in Oil* | Mixing Temperature | Storage Temperature |
|---|---|---|---|
| Sample | (wt %) | (° C.) | (° C.) |
| A-2-A | 5 | 10 | 10 |
| A-2-B | 5 | 10 | 30 |
| A-3-A | 10 | 10 | 10 |
| A-3-B | 10 | 10 | 30 |
| B-2 | 5 | 30 | 30 |
| B-3 | 10 | 30 | 30 |
| C-1 | 2.5 | 40 | 40 |
| C-2 | 5 | 40 | 40 |
| C-3 | 10 | 40 | 40 |
| D-2 | 5 | 20 | 20 |
| D-3 | 10 | 20 | 20 |

*Lecithin content of all samples is 0.7 wt %

### Pourability Analysis

Pourability of fat-in-oil blends was analyzed immediately after sample production and after 3-week storage at the desired temperature. The method employed for this analysis is described above.

### Viscosity Analysis

Viscosity of the fat-in-oil blends was measured after 3-week storage using a Brookfield viscometer. The measurement was realized after 10 seconds using a spindle S-64, at a speed of 1.5 r.p.m.

### Stability Analysis

Fat-in-oil blends were stored at a certain temperature for 3 weeks. Stability of the samples was assessed by visual examination and analysis of the oil exudation.

### Results

### Pourability and Viscosity Results

Pourability Immediately after Preparation of Samples

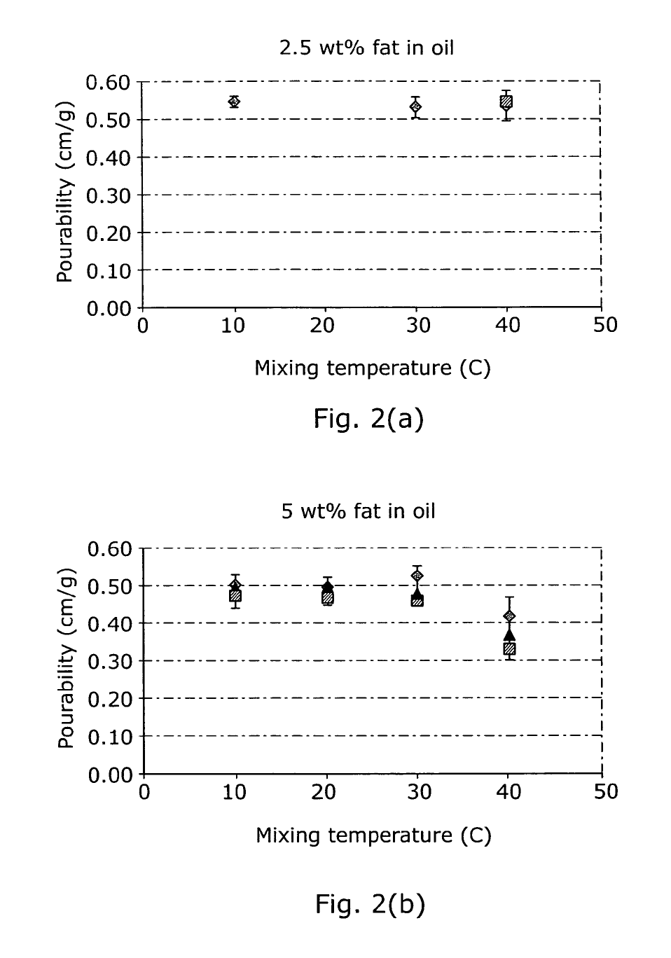

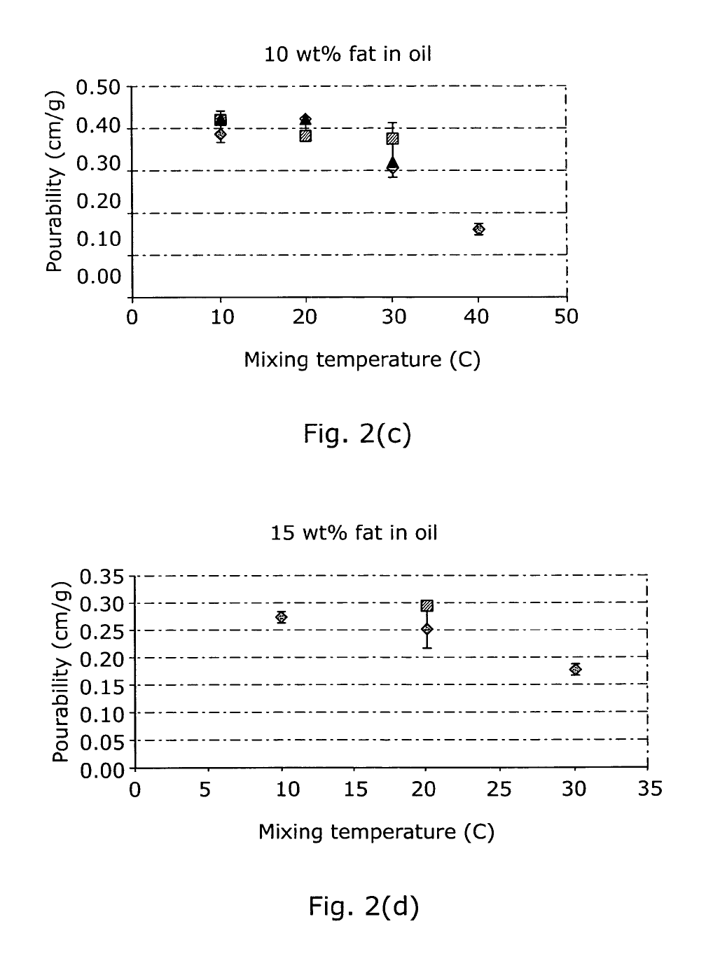

FIG. 2 shows the pourability of the fat-in-oil blends immediately after their production:

FIG. 2a) 2.5 wt % fat in oil;
FIG. 2b) 5 wt % fat in oil;
FIG. 2c) 10 wt % fat in oil; and
FIG. 2d) 15 wt % fat in oil.

From these results, it is observed that an increase in the mixing temperature leads to a decrease of the pourability and this effect is more severe when the fat content of the blend is higher. Pourability of samples with 2.5 wt % fat content does not change significantly within the temperature range considered. Samples containing 5 wt % fat content show an important decrease of pourability at 40° C. while the pourability of samples with 10 and 15 wt % fat content show a severe decrease at approximately 30° C. Therefore, for each fat concentration there seems to be a temperature which triggers the structuring properties of the powder. The pourability of samples decreases with an increase in the fat content.

Pourability and Viscosity after 3-Week Storage

Pourability and viscosity data of the fat-in-oil blends after 3-week storage are shown in Table 2. These analyses were carried out after stirring the samples with a spoon in order to blend the exudated oil again and get homogeneous mixtures.

TABLE 2
Pourability and viscosity results after 3-week storage.

| | T_{M} | T_{S} | Composition | Pourability | Viscosity |
|---|---|---|---|---|---|
| Sample | (° C.) | (° C.) | (wt % fat in oil) | (cm/g) | (cP) |
| A-2-A | 10 | 10 | 5 | 0.52 | no reading |
| A-2-B | 10 | 30 | 5 | 0.28 | 19700 |
| A-3-A | 10 | 10 | 10 | 0.44 | 1400 |
| A-3-B | 10 | 30 | 10 | 0.16 | 172000 |
| B-2 | 30 | 30 | 5 | 0.27 | 19300 |
| B-3 | 30 | 30 | 10 | 0.12 | 168500 |
| C-1 | 40 | 40 | 2.5 | 0.60 | no reading |
| C-2 | 40 | 40 | 5 | 0.46 | 799.8 |
| C-3 | 40 | 40 | 10 | 0.37 | 2000 |
| D-2 | 20 | 20 | 5 | 0.43 | 1200 |
| D-3 | 20 | 20 | 10 | 0.17 | 82000 |

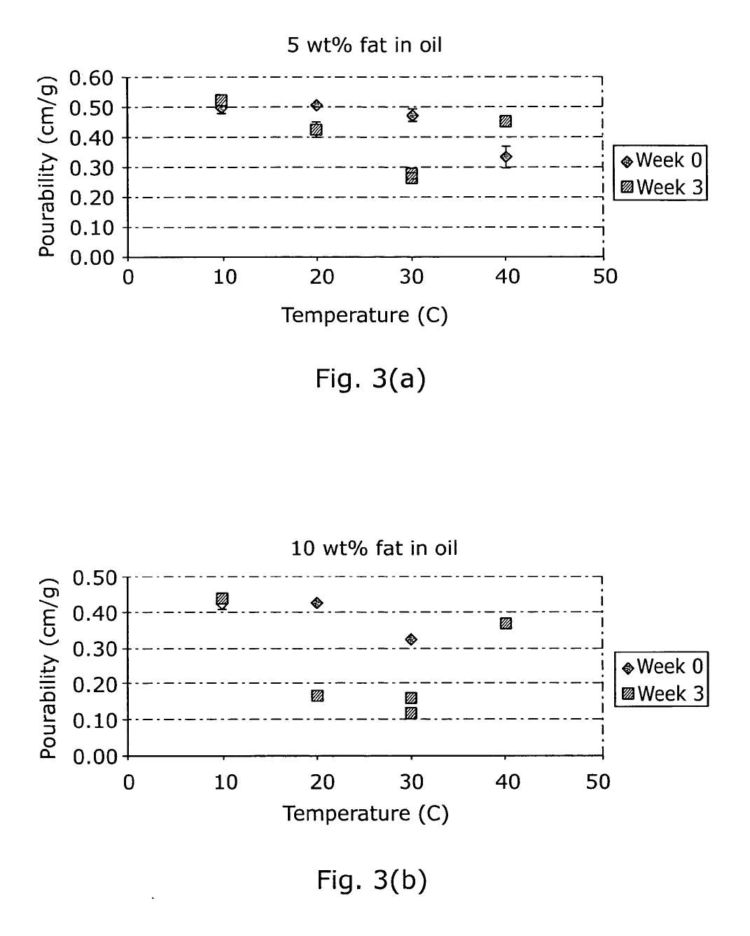

In addition, FIG. 3 below shows a comparison between the pourability of the samples immediately after their preparation (week 0) and after 3 weeks' storage.

FIG. 3a) 5 wt % fat in oil; and
FIG. 3b) 10 wt % fat in oil.

From the results shown in the previous table it can be concluded that pourability and viscosity results correlate well as both results allow reaching the same conclusions. However, samples A-3-B and D-3 seemed to have similar pourability while the viscosity of sample D-3 is significantly lower. From the visual observation of the samples, sample D-3 seemed to be more pourable (and, therefore, less viscous than sample A-3-B (consistent with the viscosity data).

Samples stored at lower temperatures prove to be more pourable (and, therefore, less viscous).

Mixing the samples at a low temperature does not have a significant effect on pourability/viscosity as long as samples are stored at a higher temperature than the mixing temperature.

Samples both mixed and stored at low temperature (10° C.) showed no significant change on pourability before and after the stability test.

Samples mixed and/or stored at higher temperatures (20° C. and 30° C.) show a significant decrease in their pourability. Nevertheless, samples stored at 40° C. show higher pourability after storage. This might be due to the fact that when the temperature is increased from 30° C. to 40° C. the percentage of solid fat of the fat powder decreases from 89% to 78% (according to the product description of the vegetable fat used in the tests), being the sample, therefore, more pourable.

FIGS. 3a) and 3b) show a surprising effect of the invention, namely that the pourability passes through a minimum as temperature increases. This unexpected effect shows the importance of selecting the correct storage temperature for a given type of fat particles. The pourability may be too low for commercial acceptability of the composition if the storage temperature is within the range of the minimum of the pourability value.

### Stability Results (Oil Exudation)

Stability of samples was evaluated for 3 weeks by visual examination of the samples and analysis of the oil exudation. Effects of storage and mixing temperatures, and fat concentration on stability were assessed.

From the results obtained in the stability test, the following conclusions were reached:

### Effect of Storage Temperature

The lower the storage temperature, the whiter and more opaque the samples.

As the storage temperature decreases, the thickness of the oil layer increases, which means that the structuring capability of the powder is lower resulting in a less stable sample. However, samples stored at 40° C. are less stable than samples stored at lower temperatures. This might be due to the fact that at 40° C. the percentage of solid fat is 78% while at lower temperatures this percentage is above 89%.

Samples which contain 10 wt %-fat and were stored at 30° C. do not show oil exudation, being therefore the most stable samples.

### Effect of Mixing Temperature

Sample B-2 (TM=30° C., TS=30° C., 5 wt %-fat content) showed oil exudation in day 6 of the test while sample A-2-B (TM=10° C., TS=30° C., 5 wt %-fat content) showed it in day 1. Additionally, oil layer in sample B-2 was thinner. Hence, an increase in the mixing temperature results in less oil exudation, being the sample, therefore, more stable. However, this effect is not appreciated for samples with 10 wt %-fat content as, in that case, both samples, A-3-B and B-3, showed no oil exudation.

### Effect of Fat Content

As the fat content of the samples increases, the samples look whiter and more opaque.

As expected, samples are more stable when the fat content is higher.

1. A method of providing a pourable edible oil composition, suitable for use in the preparation of a food product and comprising from 1% to 15% by weight of fat particles dispersed in a liquid oil, comprising mixing from 1% to 15% by weight of micronized fat particles with a liquid oil and storing the resulting composition for up to 10 weeks, wherein the mixing and storing conditions provide the composition in a form after storage that is pourable.

2. Method as claimed in claim 1, wherein the composition after storage has a pourability of from 0.2 to 0.6 cm/g.

3. Method as claimed in claim 1, wherein the composition after storage has a viscosity of less than 30,000 cP as determined using a Brookfield viscometer after 10 seconds using a spindle S-64, at a speed of 1.5 rpm.

4. Method as claimed in claim 1, wherein the fat particles and the liquid oil are mixed under low shear.

5. Method as claimed in claim 4, wherein the liquid oil comprises sunflower oil.

6. Method as claimed in claim 5, wherein the fat particles are produced by a method which comprises spraying a mixture of liquid fat containing a gas in a liquefied or supercritical state.

7. Method as claimed in claim 6, wherein the fat particles and the liquid oil are mixed at a temperature of from 5° C. to 40° C.

8. Method as claimed in claim 7, wherein the composition is stored at a temperature of from 6° C. to 35° C. for up to 6 weeks.

9. Method as claimed in claim 8, wherein the fat particles comprise a cocoa butter equivalent (CBE), cocoa butter or palm oil stearin.

10. Method as claimed in claim 9, wherein the structuring properties of the fat particles can be released when the food product is manufactured.

11. A pourable edible oil composition, suitable for use in the preparation of a food product, comprising from 1% to 15% by weight of fat particles dispersed in a liquid oil, wherein the composition has a pourability of from 0.2 to 0.6 cm/g and/or a viscosity of less than 30,000 cP as determined using a Brookfield viscometer after 10 seconds using a spindle S-64, at a speed of 1.5 rpm.

12. A composition as claimed in claim 11, wherein the liquid oil comprises sunflower oil and/or the fat particles comprise a cocoa butter equivalent (CBE), cocoa butter or palm oil stearin.

13. A method of making a food product comprising mixing the composition of claim 11 with one or more further edible components.

14. Method as claimed in claim 13, wherein the food product is a confectionery product, a margarine or a spread.

15. Use of the composition of claim 11 in the manufacture of a food product.
